(19) United States
(12) Patent Application Publication
(10) Pub. No.: US 2012/0313818 A1
(43) Pub. Date: Dec. 13, 2012

(54) ACTIVE ELECTRONICALLY SCANNED ARRAY (AESA) CARD

(75) Inventors: Angelo M. Puzella, Marlborough, MA (US); Patricia S. Dupuis, Medway, MA (US); Craig C. Lemmler, Medway, MA (US); Donald A. Bozza, Billerica, MA (US); Kassam K. Bellahrossi, Pelham, NH (US); James A. Robbins, Groton, MA (US); John B. Francis, Littleton, MA (US)

(73) Assignee: Raytheon Company, Waltham, MA (US)

(21) Appl. No.: 13/295,437

(22) Filed: Nov. 14, 2011

Related U.S. Application Data
(63) Continuation-in-part of application No. 12/484,626, filed on Jun. 15, 2009, now Pat. No. 8,279,131.

(51) Int. Cl. H01Q 21/00

(52) U.S. Cl. 342/371

(57) ABSTRACT

In one aspect, an active electronically scanned array (AESA) card includes a printed wiring board (PWB) that includes a first set of metal layers used to provide RF signal distribution, a second set of metal layers used to provide digital logical distribution, a third set of metal layers used to provide power distribution and a fourth set of metal layers used to provide RF signal distribution. The PWB comprises at least one transmit/receive (T/R) channel used in an AESA.

### RELATED APPLICATIONS

This patent application is a continuation-in-part to application Ser. No. 12/484,626, filed Jun. 15, 2009 and titled “PANEL ARRAY,” which is incorporated herein in its entirety.

### BACKGROUND

As is known in the art, a phased array antenna includes a plurality of active circuits spaced apart from each other by known distances. Each of the active circuits is coupled through a plurality of phase shifter circuits, amplifier circuits and/or other circuits to either or both of a transmitter and receiver. In some cases, the phase shifter, amplifier circuits and other circuits (e.g., mixer circuits) are provided in a so-called transmit/receive (T/R) module and are considered to be part of the transmitter and/or receiver.

The phase shifters, amplifier and other circuits (e.g., T/R modules) often require an external power supply (e.g., a DC power supply) to operate correctly. Thus, the circuits are referred to as “active circuits” or “active components.” Accordingly, phased array antennas which include active circuits are often referred to as “active phased arrays.” An active phased array radar is also known as an active electronically scanned array (AESA).

Active circuits dissipate power in the form of heat. High amounts of heat can cause active circuits to be inoperable. Thus, active phased arrays should be cooled. In one example heat-sink(s) are attached to each active circuit to dissipate the heat.

### SUMMARY

In one aspect, an active electronically scanned array (AESA) card includes a printed wiring board (PWB) that includes a first set of metal layers used to provide RF signal distribution, a second set of metal layers used to provide digital logical distribution, a third set of metal layers used to provide power distribution and a fourth set of metal layers used to provide RF signal distribution. The PWB comprises at least one transmit/receive (T/R) channel used in an AESA.

In another aspect, an active electronically scanned array (AESA) assembly includes an AESA card that includes a printed wiring board (PWB). The PWB includes a first set of metal layers used to provide RF signal distribution, a second set of metal layers used to provide digital logical distribution, a third set of metal layers used to provide power distribution and a fourth set of metal layers used to provide RF signal distribution. The AESA assembly also includes one or more monolithic microwave integrated circuits (MMICs) disposed on the surface of the PWB. The PWB includes at least one transmit/receive (T/R) channel used in an AESA.

### DESCRIPTION OF THE DRAWINGS

FIG. 1A is a diagram of an active electronically scanned array (AESA) with an array of active electronically scanned array (AESA) cards disposed on a mobile platform.

FIG. 1B is a diagram of the array of AESA cards in FIG. 1A.

FIG. 2 is a diagram of an example of an AESA card with monolithic microwave integrated circuits (MMICs) disposed on the surface of the AESA card.

FIG. 3 is a cross-sectional view of an AESA assembly with an AESA card, MMICs and a cooling mechanism.

FIG. 4 is a cross-sectional view of a printed wiring board (PWB).

### DETAILED DESCRIPTION

Previous approaches to integrating active Monolithic Microwave Integrated Circuits (MMIC) for each active electronically scanned array (AESA) Transmit/Receive (T/R) Channel included disposing these components in a metal container (sometimes called a “T/R Module”), which results in an expensive assembly. In addition to high material and test labor costs, extensive non-recurring engineering (NRE) is required for changes in AESA architecture (e.g., changes in active aperture size, lattice changes, number of T/R channels per unit cell and so forth) or cooling approach. These previous approaches also use wire bonds that are used for radio frequency (RF), power and logic signals for the T/R module; however, RF wire bonds can cause unwanted electromagnetic coupling between T/R channels or within a T/R channel.

Described herein is a new T/R Channel architecture, an AESA card. The AESA card reduces assembly recurring cost and test time and significantly reduces NRE for new applications or the integration of new MMIC technologies into AESA applications. The AESA card may be fabricated using fully automated assembly process and allows for ease of modifying lattice dimensions and the number of T/R channel cells per assembly. The AESA card includes no wire bonds thereby significantly reducing if not eliminating electromagnetic coupling between T/R channels or within a T/R channel and other electromagnetic interference (EMI). Thus, there is consistent channel-to-channel RF performance.

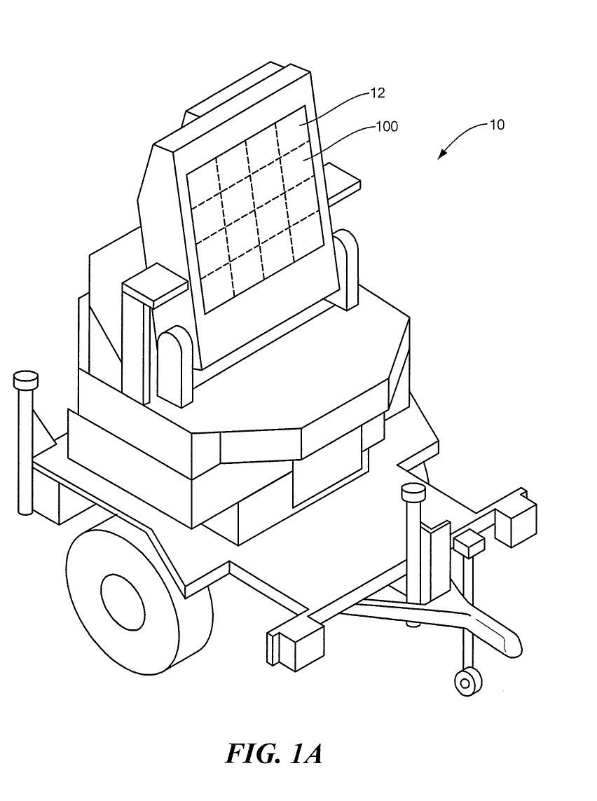

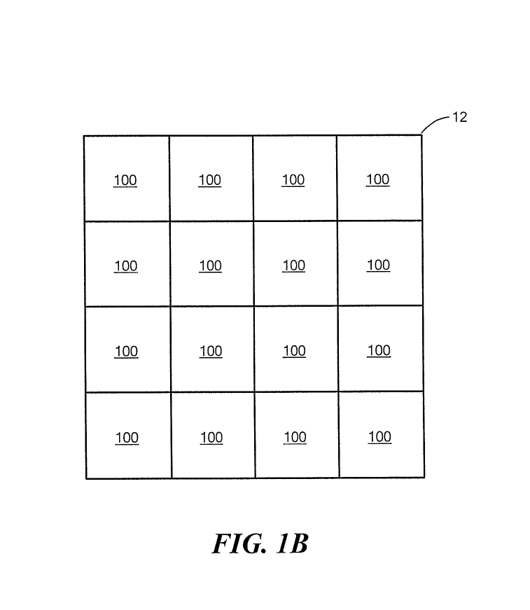

Referring to FIGS. 1A and 1B, an AESA card may be used in a number of applications. For example, as shown in FIG. 1A, an array 12 of AESA cards 100 may be used in a mobile environment such as in a mobile platform unit 10. In this example, the AESA cards 100 are arranged in a 4×4 array. Though FIGS. 1A and 1B depict AESA cards 100 that are in a shape of a rectangle, they may be constructed to be a circle, triangle or any polygon shape. Also, though the array 12 is in a shape of a square the array may be a rectangle, circle, triangle or any polygon arrangement. Further, the number of AESA cards 100 may be one to any number of AESA cards 100.

In other applications, one or more AESA cards 100 may be used on the side of naval vessels, on ground structures and so forth. As will be shown herein an AESA card 100 is a “building block” to building an AESA system.

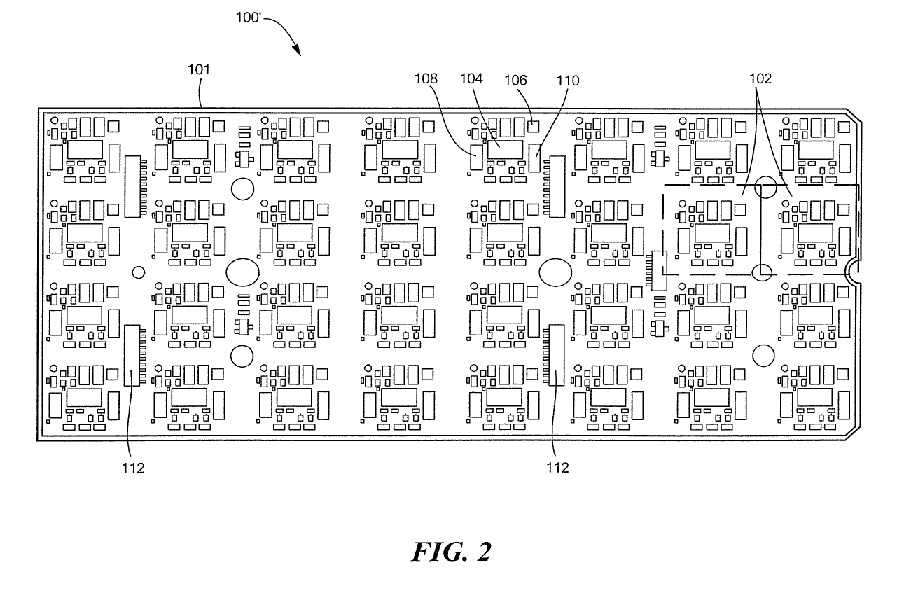

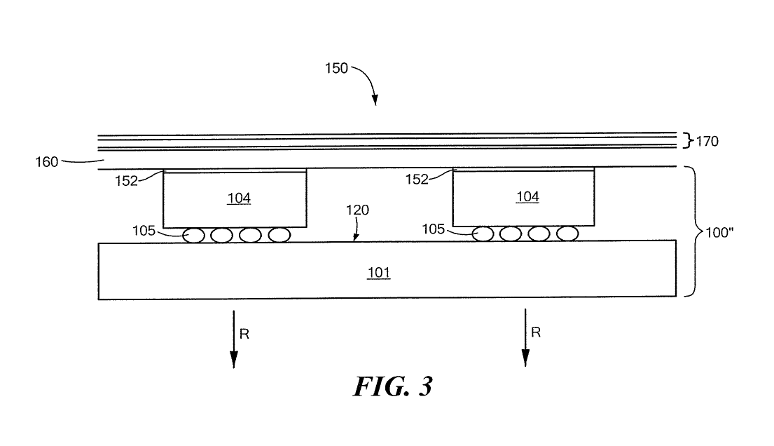

Referring to FIG. 2, an example of an AESA card 100 is an AESA card 100′ that includes a printed wiring board (PWB) 101 and MMICs 104 (e.g., flip chips) on a surface of the PWB 101 (e.g., a surface 120 shown in FIG. 3). In this example, the AESA card 100′ includes a 4×8 array of T/R channel cells 102 or 32 T/R channel cells 102. Each T/R channel cell 102 includes the MMICs 104, a drain modulator 106 (e.g., a drain modulator integrated circuit (IC)), a limiter and low noise amplifier (LNA) 108 (e.g., a gallium-arsenide (GaAs) LNA with limiter), a power amplifier 110 (e.g., a gallium-nitride (GaN) power amplifier). The AESA card 100′ also includes one or more power and logic connectors 112. Though the T/R channel cells 102 are arranged in a rectangular array, the T/R channel cells 102 may be arranged in a circle, triangle or any type of arrangement.

Referring to FIG. 3, an AESA assembly 150 includes an AESA card (e.g., an AESA card 100″) with the PWB 101 and MMICs 104 disposed on the surface 120 of the PWB 101 by solder balls 105. The AESA assembly 150 also includes a thermal spreader plate 160 coupled to each of the MMICs through thermal epoxy 152 and a cold plate 170. The cold plate 170 includes a channel 172 to receive a fluid such as a gas or a liquid to cool the MMICs 104. Thus, each MMIC 104 is heat sunk in parallel. That is, the thermal resistance from the heat source (e.g., MMICs 104) to the heat sink (cold plate 170) is the same for all MMICs 104 and components (e.g., the drain modulator 106, the LNA 108, the power amplifier 110 and so forth) in each T/R channel cell 102 across the AESA card 100″ thereby reducing the thermal gradient between T/R channel cells 102. The AESA card 100″ radiates RF signals in the R direction.

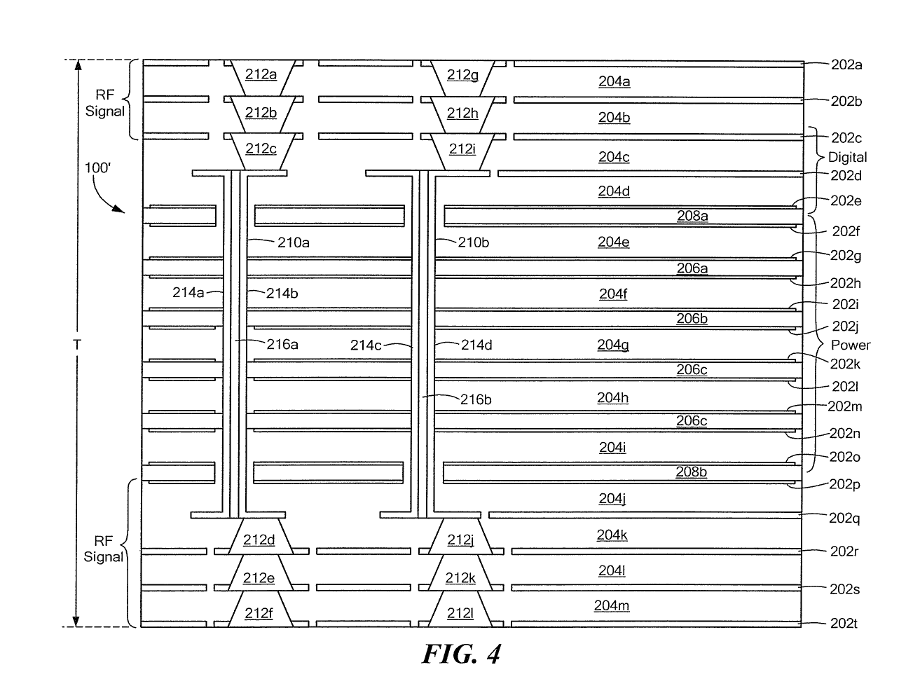

Referring to FIG. 4, an example of a printed wiring board (PWB) 101 is a PWB 101′. In one example, the thickness, t of the PWB 101′ is about 64 mils.

The PWB 101′ includes metal layers (e.g., metal layers 202a-202t) and one of an epoxy-resin layer (e.g., epoxy-resin layers 204a-204m), a polyimide dielectric layer (e.g., polyimide dielectric layers 206a-206d) or a composite layer (e.g., composite layers 208a, 208b) disposed between each of the metal layers (202a-202t). In particular, the composite layer 208a is disposed between the metal layers 210e, 210f and the composite layer 208b is disposed between the metal layers 210o, 210p. The polyimide dielectric layer 206a is disposed between the metal layers 202g, 202h, the polyimide dielectric layer 206b is disposed between the metal layers 202i, 202j, the polyimide dielectric layer 206c is disposed between the metal layers 202k, 202l and the polyimide dielectric layer 206d is disposed between the metal layers 202m, 202n. The remaining metals layers include an epoxy-resin layer (e.g., one of epoxy-resin layers 204a-204m) disposed between the metal layers as shown in FIG. 4.

The PWB 101′ also includes RF vias (e.g., RF vias 210a, 210b) coupling the metal layer 202d to the metal layer 202q. Each of the RF vias 210a, 210b includes a pair of metal plates (e.g., the RF via 210a includes metal plates 214a, 214b and the RF via 210b includes metal plates 214c, 214d). The metal plates 214a, 214b are separated by an epoxy resin 216a and the metal plates 214c, 214d are separated by an epoxy resin 216b. Though not shown in FIG. 4, one of ordinary skill in the art would recognize that other type vias exist for the digital logic layers and the power layers to bring these signals to a surface of the AESA card 100″ or to other metal layers.

The PWB 101′ also includes metal conduits (e.g., metal conduits 212a-212l) to electrically couple the RF vias 210a, 210b to the metal layers 202a, 202t. For example, the metal conduits 212a-212c are stacked one on top of the other with the metal conduit 212a coupling the metal layer 202a to the metal layer 202b, the metal conduit 212b coupling the metal layer 202b to the metal layer 202c and the metal conduit 212c coupling the metal layer 202c to the metal layer 202d and to the RF via 210a. The metal conduits 212a-212l are formed by drilling holes (e.g., about 4 or 5 mils in diameter) into the PWB 101′ and filling the holes with a metal.

Further, the metal conduits 212d-212f are stacked one on top of the other with the metal conduit 212d coupling the metal layer 202r and the RF via 210a to the metal layer 202s, the metal conduit 212e coupling the metal layer 202s to the metal layer 202t and the metal conduit 212f coupling the metal layer 202t to the metal layer 202u.

The metal layers 202a-202c and the epoxy-resin layers 204a-204b are used to distribute RF signals. The metal layers 202p-202t, the epoxy-resin layers 204j-204m are also used to distribute RF signals. The metal layers 202c-202e and the epoxy-resin layers 204c-204d are used to distribute digital logic signals. The metal layers 202f-202o, the epoxy-resin layers 204e-204i and the polyimide dielectric layers 206a-206d are used to distribute power.

In one example, one or more of the metal layers 202a-202r includes copper. Each of metal layers 202a-202t may vary in thickness from about 0.53 mils to about 1.35 mils, for example. In one example the RF vias 210a, 210b are made of copper. In one example, the metal conduits 212a-212l are made of copper.

In one example, each of the epoxy-resin layers 204a-204m includes a high-speed/high performance epoxy-resin material compatible with conventional FR-4 processing and has mechanical properties that make it a lead-free assembly compatible to include: a glass transition temperature, Tg, of about 200° C. (Differential scanning calorimetry (DSC)), a coefficient of thermal expansion (CTE)<Tg 16, 16 & 55 ppm/° C. and CTE>Tg 18, 18 & 230 ppm/° C. The low CTE and a high Td (decomposition temperature) of 360° C. are also advantageous in the sequential processing of the stacked metal conduits 212a-212l. Each of the epoxy-resin layers 204a-204m may vary in thickness from about 5.6 mils to about 13.8 mils, for example. In one particular example, the epoxy-resin material is manufactured by Isola Group SARL under the product name, FR408HR. In one example, the epoxy resin 216a, 216b is the same material used for the epoxy-resin layers 204a-204m.

In one example, each of the polyimide dielectric layers 206a-206d includes a polyimide dielectric designed to function as a power and ground plane in printed circuit boards for power bus decoupling and provides EMI and power plane impedance reduction at high frequencies. In one example, each of the polyimide dielectric layers is about 4 mils. In one particular example, the polyimide dielectric is manufactured by DUPONT® under the product name, HK042536E.

In one example, each of the composite layers 208a, 208b includes a composite of epoxy resin and carbon fibers to provide CTE control and thermal management. In one example, the composite layers may be function as a ground plane and also may function as a mechanical restraining layer. In one example, each of the composite layers is about 1.8 mils. In one particular example, the composite of epoxy resin and carbon fibers is manufactured by STABLCOR® Technology, Inc. under the product name, ST10-EP387.

In one example, the materials described above with respect to fabricating an AESA card are lead-free. Thus, the solution proposed herein is meets environmental regulations requiring products that are lead-free.

The processes described herein are not limited to the specific embodiments described. Elements of different embodiments described herein may be combined to form other embodiments not specifically set forth above. Other embodiments not specifically described herein are also within the scope of the following claims.

What is claimed is:

1. An active electronically scanned array (AESA) card comprising:
a printed wiring board (PWB) comprising:
a first set of metal layers used to provide RF signal distribution;
a second set of metal layers used to provide digital logical distribution;
a third set of metal layers used to provide power distribution; and
a fourth set of metal layers used to provide RF signal distribution,
wherein the PWB comprises at least one transmit/receive (T/R) channel used in an AESA.

2. The AESA card of claim 1 wherein the plurality of layers further comprises:
a first composite layer of carbon fibers and epoxy between a metal layer of the second set of metal layers and a metal layer of the third set of metal layers; and
a second composite layer of carbon fibers and epoxy between a metal layer of the third set of metal layers and a metal layer of the fourth set of metal layers.

3. The AESA card of claim 2 wherein the PWB further comprises:
a layer of epoxy resin between two metal layers of the first set of metal layers;
a layer of epoxy resin between two metal layers of the second set of metal layers; and
a layer of epoxy resin between two metal layers of the first set of metal layers.

4. The AESA card of claim 2 wherein the PWB further comprises a layer of polyimide dielectric between two metal layers of the third set of metal layers.

5. The AESA card of claim 1, further comprising one or more monolithic microwave integrated circuits (MMICs) disposed on the surface of the PWB.

6. The AESA card of claim 1 wherein the MMICs are attached to the PWB using solder balls.

7. The AESA card of claim 1 wherein the plurality of layers comprises:
a plurality of metal conduits, each electrical conduit coupling one of the plurality of layers to another one of the plurality of layers.

8. The AESA card of claim 7, further comprising an RF via having a first end coupled to a first metal conduit and a second end opposite to the first end coupled to a second metal conduit,
wherein the RF via extends through metal layers used for power distribution.

9. The AESA card of claim 1 wherein the PWB further comprises:
a layer of epoxy resin between two metal layers of the first set of metal layers;
a layer of epoxy resin between two metal layers of the second set of metal layers;
a layer of epoxy resin between two metal layers of the first set of metal layers; and
a layer of polyimide dielectric between two metal layers of the third set of metal layers.

10. The AESA card of claim 1 wherein the AESA card does not include wire bonds.

11. An active electronically scanned array (AESA) assembly comprising:
an AESA card comprising a printed wiring board (PWB) comprising:
a first set of metal layers used to provide RF signal distribution;
a second set of metal layers used to provide digital logical distribution;
a third set of metal layers used to provide power distribution; and
a fourth set of metal layers used to provide RF signal distribution; and
one or more monolithic microwave integrated circuits (MMICs) disposed on the surface of the PWB,
wherein the PWB comprises at least one transmit/receive (T/R) channel used in an AESA.

12. The ASEA assembly of claim 11, further comprising a cooling mechanism in contact with the one or more of the MMICs.

13. The ASEA assembly of claim 12 wherein the cooling mechanism comprises:
a thermal heat spreader in contact with the MMICs; and
a cold plate in contact with the thermal spreader.

14. The ASEA assembly of claim 13 wherein the MMICs are attached to the PWB using solder balls.

15. The ASEA assembly of claim 11 wherein the plurality of layers comprises:
a plurality of metal conduits, each electrical conduit coupling one of the plurality of layers to another one of the plurality of layers.

16. The ASEA assembly of claim 15, further comprising a via having a first end coupled to a first metal conduit and a second end opposite to the first end connected to a second metal conduit,
wherein the via extends through metal layers used for power distribution.

17. The ASEA assembly of claim 11 wherein the plurality of layers further comprises:
a first composite layer of carbon fibers and epoxy between a metal layer of the second set of metal layers and a metal layer of the third set of metal layers; and
a second composite layer of carbon fibers and epoxy between a metal layer of the third set of metal layers and a metal layer of the fourth set of metal layers.

18. The ASEA assembly of claim 17 wherein the plurality of layers further comprises:
a layer of epoxy resin between two metal layers of the first set of metal layers;
a layer of epoxy resin between two metal layers of the second set of metal layers;
a layer of epoxy resin between two metal layers of the first set of metal layers; and
a layer of polyimide dielectric between two metal layers of the third set of metal layers.

19. The ASEA assembly of claim 11 wherein the AESA card does not include wire bonds.
